(19) United States
(12) Patent Application Publication
(10) Pub. No.: US 2006/0192028 A1
(43) Pub. Date: Aug. 31, 2006

(54) Hydraulically intensified injectors with passive valve and methods to help needle closing

(75) Inventor: Tibor Kiss, Manitou Springs, CO (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(73) Assignee: Sturman Industries, Inc.

(21) Appl. No.: 11/355,603

(22) Filed: Feb. 15, 2006

Related U.S. Application Data
(60) Provisional application No. 60/657,176, filed on Feb. 28, 2005.

(51) Int. Cl. F02M 47/02

(52) U.S. Cl. 239/88

(57) ABSTRACT

Hydraulically intensified injectors with passive valve and methods to help needle closing. In accordance with the method, at the end of injection, a passive valve is used to couple the expanding high pressure fuel remaining in the nozzle to temporarily hydraulically encourage the needle to close, thereby initiating needle closing prior to the time a needle return spring can start moving the needle to the closed position. Multiple embodiments are disclosed.

### CROSS-REFERENCE TO RELATED APPLICATION

This application claims the benefit of U.S. Provisional Patent Application No. 60/657,176 filed Feb. 28, 2005.

### BACKGROUND OF THE INVENTION

1. Field of the Invention

The present invention relates to the field of fuel injection.

2. Prior Art

A preferred embodiment of the present invention improves the performance of an injector currently used in International V8 Diesel engines, known as the G2.8 injector, and in general, will improve the performance of a class of diesel injectors commonly known in the industry as Hydraulic Electronic Unit Injectors (HEUI). These injectors use an intensifier to increase a rail pressure to the fuel injection pressure. In that regard, the present invention is not necessarily limited to intensified injectors, as its operation is not dependent on the presence of an intensifier. Since exemplary constructions, operation and advantages of the present invention will be described with respect to the prior art G2.8 injector, that injector will be referred to herein as the prior art injector.

A sharp end of injection (quickly falling injection pressure prior to end of fuel injection) is advantageous for obtaining low emissions, especially particulate emissions, in a diesel engine. A sharp end of injection is also helpful to reduce injection duration for the same quantity of fuel injected, and also can reduce the minimum quantity that can be injected with acceptable consistency. One purpose of the present invention is to provide a sharp end of injection.

In the prior art injector, injection ends when the needle is pushed down against its seat by the needle spring. In order for the spring to be able to move the needle, the pressure has to drop to the so-called VCP (valve closing pressure). The VCP, for a practically sized spring, is on the order of 200 bar. Therefore, in the prior art injector, the nozzle pressure has to drop from 2000 bar to 200 bar before the needle starts its closing motion. After the needle starts moving downward, the nozzle pressure still keeps dropping from the 200 bar VCP. If the pressure in the nozzle becomes lower than engine cylinder pressure before the needle is fully closed, airflow from engine cylinder to the injector nozzle would occur. This airflow is detrimental for injector durability and controllability. To prevent that, the rate of pressure drop is intentionally slowed with the implementation of a check disk between the intensifier and the nozzle. When the intensifier is depressurized, the compressed fuel between the check disk and the nozzle spray-holes becomes trapped, and its pressure drops relatively slowly because it can only expand through the spray-holes and through an orifice in the check disk. This way, the pressure does not drop too fast, and the needle can close before the pressure in the nozzle drops below engine cylinder pressure, thereby preventing combustion chamber content ingestion into the nozzle.

An unintended consequence of the above method of slowing down the rate of nozzle pressure drop between VCP and engine cylinder pressure is that the nozzle pressure is dropping slowly from peak injection pressure of 2000 bar to VCP as well. The result is that a significant amount of fuel is injected at lower than ideal injection pressures, and injection duration for the same injected quantity is also longer than ideal. Lower injection pressure is a definite disadvantage in terms of emission performance. Too long an injection duration is also disadvantageous because at high engine speeds, it may not be possible to inject all the fuel in the available time window. The elongated end of injection also means that the minimum fuel quantity that could be injected with acceptable consistency is higher than would be possible with a sharp end of injection.

### BRIEF DESCRIPTION OF THE DRAWINGS

FIG. 1 is a diagram illustrating an intensifier and its control exemplary of the prior art injector and of the preferred embodiments of injectors in accordance with the present invention.

FIG. 2 illustrates the prior art injector below the intensifier of FIG. 1.

FIG. 3 illustrates an embodiment of injector in accordance with the present invention below the intensifier of FIG. 1.

FIG. 4 illustrates another embodiment of the present invention similar to the embodiment of FIG. 1.

### DETAILED DESCRIPTION OF THE PREFERRED EMBODIMENTS

The preferred embodiments presented herein address the disadvantages of the prior art injector by increasing the nozzle pressure at which the needle closing motion can commence. With the early start of needle closing, the pressure in the nozzle can be dropped very quickly, and the needle will still close before nozzle pressure reaches engine cylinder pressure. Also, the needle can be fully closed at nozzle pressures that are much higher than the VCP for the prior art injector.

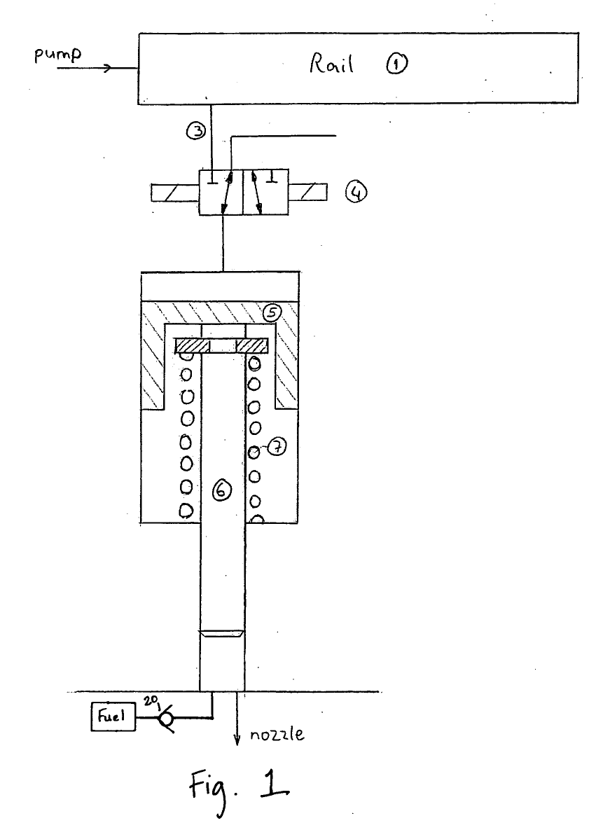

FIG. 1 illustrates an intensifier that is common to the prior art injectors and to preferred embodiments of the present invention injectors. The intensifier is shown because it helps facilitate the explanation of injector operation. However, the intensifier may be in accordance with the prior art. In that regard, FIG. 1 simply illustrates a controllable source of fuel under pressure, obtained by controllably coupling region over piston 5 to an actuation fluid under pressure in the rail 1 or to a vent V. It will be understood however, that while the fluid under pressure in rail 1 is engine oil for the prior art injector, fuel or another hydraulic fluid may be used with the present invention. Further, if fuel is used, valving could be used to controllably couple the injector nozzle directly to pressurized fuel in the rail 1, or to a vent, in which case the fuel in the rail would typically be at a higher pressure than an actuating fluid for use to power an intensifier.

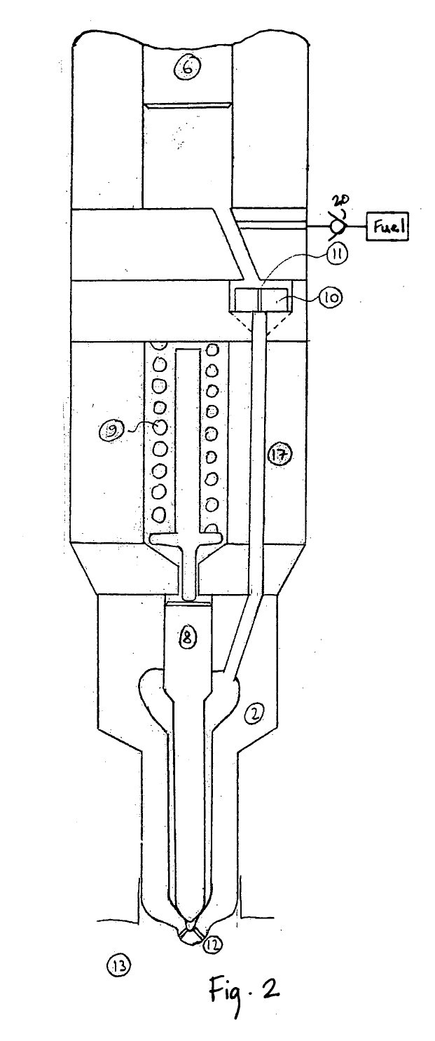

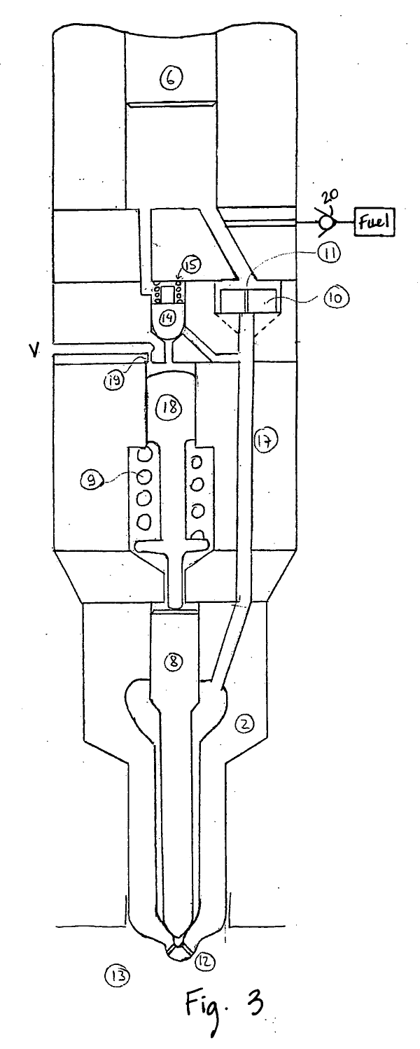

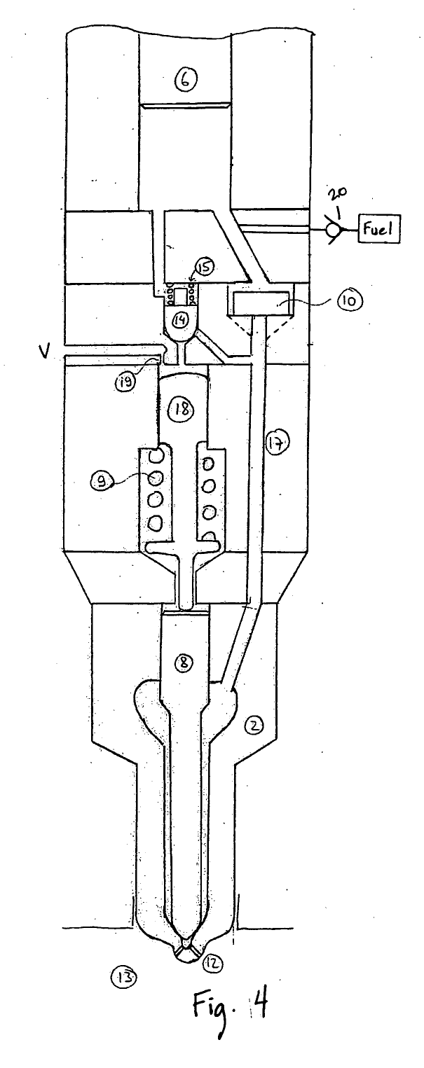

FIG. 2 illustrates the prior art injector below the intensifier of FIG. 1, and FIGS. 3 and 4 show embodiments of the present invention injector below the intensifier. For the operation of the injector, a rail 1 containing actuating fluid (could be diesel fuel or any hydraulic oil) is needed. For the prior art injector, the rail fluid is at a ‘medium’ pressure, which is typically lower than the pressure in the nozzle 2 during injection. The rail is connected to the injector via a hydraulic line 3 that could be a tube or a drilled hole through a block of metal. The hydraulic line feeds the supply port of one or more intensifier valves 4 (one valve with one intensifier piston is shown in FIG. 1, although several of each may be present). The intensifier valves are typically 3-way valves that connect the rail 1 to the top of the intensifier pistons 5 when energized, and connect the top of the intensifier pistons 5 to vent, when de-energized, although other valve configurations such as two two-way valves could also be used. The intensifier pistons are in contact with an intensifier plunger 6. There also may be a spring 7 to return the intensifier pistons 5 and plunger 6 to their upper position when the intensifier valves 4 are de-energized, fuel beneath the plunger 6 being replenished through check valve 20. Injection is commanded by energizing the intensifier valves 4, thereby putting the medium pressure fluid on top of the intensifier piston(s) 5 and pressurizing the fuel under the plunger 6 to a high pressure determined by the area ratio of the intensifier piston(s) 5 and the plunger 6. Up to this point, the prior art injector and an injector with the new invention operates the same way.

In the prior art injector., as the pressure rises, it will reach VOP (valve opening pressure), at which point the force from the pressure underneath the needle 8 is large enough to move the needle upward against the force from the needle spring 9, and injection will start. Injection will continue until the needle closes again. The process of closing the needle starts when the intensifier valves 4 are de-energized, and thereby pressure is removed from the top of the pistons 5. Then, the pressure quickly drops under the plunger 6 to vent pressure. As the pressure drops to vent pressure under the plunger, the pressurized fuel in the nozzle 2 tries to expand, generating a reverse flow from the nozzle to the chamber under the plunger 6. This reverse flow pushes the check disk 10 up against its top stop, thereby reducing the flow area connecting the nozzle 2 with the chamber under the plunger 6 to the small orifice hole 11 in the middle of the check disk 10. The expansion of the fuel in the nozzle now is very restricted, as the fuel can only expand through the tiny spray-holes 12 (injection) and through the orifice 11 in the check disk 10. The expansion is therefore slow, and the pressure in the nozzle 2 is gradually dropping. As long as the pressure is above VCP, the needle 8 does not start moving downward, and during this time injection continues at a gradually dropping injection rate, which rate is controlled by the combined effective flow areas of the spray-holes 12 and the check disk orifice 11. When the pressure in the nozzle 2 drops below VCP, the needle spring 9 force is high enough to start moving the needle 8 downward. The traveling of the needle to full closing takes time, during which the nozzle 2 pressure further drops. However, the rate of nozzle pressure drop is slow enough for the needle 8 to close before the nozzle pressure drops below engine cylinder 13 pressure, whereby air flow back from the cylinder to the injector is prevented.

In the exemplary present invention injectors of FIGS. 3 and 4, a passive valve 14 is implemented. The top of the passive valve is connected to the chamber under the plunger 6. The bottom of the passive valve 14 is connected to the top of the guided fuel pin 18 and to the nozzle line 17 under the check disk 10. The bottom surface of the passive valve 14 is spherical and it seals the top of the fuel pin 18 from the nozzle line 17 when the passive valve is in its lower position pushed against its conical seat.

The start of injection process is similar to that of the prior art injector. As pressure rises under the plunger 6, fuel flow is generated toward the nozzle 2. This flow presses the check disk 10 to its lower position, where it constitutes only a small restriction to flow. The passive valve 14 is pressurized on its top over the full area, while the bottom is pressurized only over the full area minus the area inside the seat circle of the passage to the region over the fuel pin 18. Also, the pressure under the passive valve and outside the seat circle is lower than the pressure under the plunger 6 due to the slight pressure drop through the check disk 10 while flow exists to the nozzle 2. For all these reasons, the passive valve 14, which was biased in the lower position by its spring 15, will remain in the lower position as the pressure rises under the plunger 6, and effectively cuts off fluid communication between the top of the fuel pin 18 and the nozzle line 17. As the pressure in the nozzle 2 passes VOP, the needle 8 starts moving upward and injection begins. The fuel pin 18 is pushed upward as well, and it presses out fuel from above it through the outlet orifice 19 to a vent V. The size of the outlet orifice is one of the factors in determining the needle lift velocity, and it gives a certain control over minimum injected quantity.

End of injection is commanded by de-energizing the intensifier valve(s) 4. The pressure in the chamber under the plunger 6 will quickly drop to vent pressure and the check disk 10 will move to its upper position just like for the prior art injector. The high pressure is temporarily sealed in under the check disk 10 by the check disk. The passive valve 14 now sees very low pressure on its top, and still high pressure on the bottom, outside of the seat contact circle. This pressure differential is enough to move the passive valve 14 up against the spring force very quickly. Now the fuel in the nozzle 2 has up to three paths to take for expansion. The spray-holes 12, the check disk orifice 11, if it exists as in FIG. 3 (though it may be eliminated as in the embodiment of FIG. 4), and the path through the passive valve 14 seat, which latter continues to the chamber on top of the fuel pin 18 and the outlet orifice 19 out into the vent. The pressure in the nozzle 2 will drop due to flow through these paths, but simultaneously, the pressure over the fuel pin 18 will be rising. Typically, the fuel pin would be sized for a larger diameter than the needle 8 guide diameter. Therefore even before the pressure in the nozzle 2 evens out with the pressure over the fuel pin 18, there is already a downward resultant force on the needle/fuel pin assembly from the pressures. The needle spring 9 adds even more downward force. Therefore, the needle will start moving downward before the nozzle 2 and fuel pin 18 pressures even become equal. With a properly sized and proportioned system, downward motion of the needle 8 can be started when the pressure in the nozzle 2 is around 1000 bar or higher. Even if the rate of nozzle pressure drop is high, dropping the pressure about a 1000 bar takes a relatively long time, and the needle 8 has ample time to fully close before nozzle pressure drops below engine cylinder 13 pressure. However, fast nozzle pressure drop is not needed for sharp end of injection—only a fast balancing out of the nozzle pressure with the fuel pin top pressure. That will happen fast due to the relatively large flow area though the passive valve 14, and once that balance has been achieved, the needle 8 will start moving down. Therefore, the check disk orifice 11 can be smaller than in the prior art injector, in fact, it could possibly be completely eliminated as in FIG. 4. Also, the outlet orifice 19 would be chosen to be small too. It only has to be big enough to allow fast enough needle lift at SOI.

Advantages of the new injector relative to the prior art injector include:
Sharper end of injection
Reduced injection duration for same injected quantity and peak injection pressure
High injection pressure right before the needle closes
Improved small quantity control (smaller quantity can be injected for the same rail pressure and intensifier valve energizing time interval)
Improved control of needle opening velocity through the sizing of the outlet orifice

The passive valve could be a spool valve, although leakage would be present. It could also be placed downstream of the outlet orifice, although that would lead to some short circuit loss. Furthermore, the branching off to the passive valve could take place from a number of other locations, including the nozzle kidney.

The selectively pressurizing the top of the fuel pin when end of injection is commanded, but not pressurizing the top of the fuel pin when start of injection is commanded, is achieved without the use of an actively controlled valve separate from the intensifier valve(s). Instead, the pressurization of the top of the fuel pin is controlled with a passive valve, which does not have its own active control, but instead reacts to the pressure changes brought about by the intensifier valve(s). Injector operation based on the present invention utilizes the volumetric expansion of the fuel in the nozzle as the nozzle is de-pressurized.

In recent years many diesel engine manufacturers have used direct needle control type fuel systems—systems in which a separate valve controls the needle motion in a more direct way than in the HEUI systems. The HEUI system has several advantages, but these advantages are hard to utilize when overshadowed with a significant disadvantage—a poor needle closing quality. By eliminating this disadvantage, the HEUI system can be competitive again. Advantages of the HEUI style injectors include faster needle motion, no sealing against high pressures, and no high pressure spikes well above injection pressure. In addition, by improving small quantity control, the new injector also closes the gap between the Direct Needle Control and the HEUI injectors, although the Direct Needle Control systems' advantage in this regard will still exist.

While certain preferred embodiments of the present invention have been disclosed and described herein for purposes of illustration and not for purposes of limitation, it will be understood by those skilled in the art that various changes in form and detail may be made therein without departing from the spirit and scope of the invention.

What is claimed is:

1. A fuel injector comprising:
an intensifier having first and second hydraulic regions;
control valving for controllably coupling an actuation fluid under pressure or a vent to the first hydraulic region;
an injector nozzle;
a needle within the injector nozzle disposed to prevent fuel flow through the injector nozzle when in a first needle position and to allow fuel flow through the injector nozzle when in a second needle position;
a spring disposed to yieldably encourage the needle toward the first needle position, the needle being encouragable toward the second needle position by fuel under pressure in the injector nozzle;
a first passage coupled between the second hydraulic region and the nozzle;
a check valve in the first passage to allow fuel flow from the second hydraulic region to the nozzle and to restrict flow from the nozzle to the second hydraulic region;
a third hydraulic region disposed to encourage the needle toward the first needle position when pressurized, the third hydraulic region being coupled to a vent through a flow restriction;
a passive valve disposed to allow flow between the nozzle and the third hydraulic region when in a first passive valve position and to block flow between the nozzle and the third hydraulic region when in a second passive valve position;
the passive valve having a fourth hydraulic region coupled to the second hydraulic region and disposed to encourage the passive valve to the second passive valve position, and a fifth hydraulic region coupled to the nozzle and disposed to encourage the passive valve to the first passive valve position.

2. The fuel injector of claim 1 further comprised of a spring disposed to encourage the passive valve to the second passive valve position.

3. The fuel injector of claim 1 wherein the check valve partially restricts flow from the nozzle to the second hydraulic region.

4. The fuel injector of claim 1 wherein the check valve fully restricts flow from the nozzle to the second hydraulic region.

5. In a fuel injector having a needle in a nozzle, the improvement comprising:
a check valve to allow fuel under pressure to flow from a controllable source of fuel under pressure to the nozzle and to restrict flow from the nozzle back to the controllable source of fuel under pressure;
a first hydraulic region disposed to encourage the needle toward a needle closed position when pressurized, the first hydraulic region being coupled to a vent through a flow restriction;
a passive valve disposed to allow flow between the nozzle and the first hydraulic region when in a first passive valve position and to block flow between the nozzle and the first hydraulic region when in a second passive valve position;
the passive valve having a second hydraulic region coupled to the controllable source of fuel under pressure and disposed to encourage the passive valve to the second passive valve position, and a third hydraulic region coupled to the nozzle and disposed to encourage the passive valve to the first passive valve position.

6. The fuel injector of claim 5 further comprised of a spring disposed to encourage the passive valve to the second passive valve position.

7. The fuel injector of claim 5 wherein the check valve partially restricts flow from the nozzle to the controllable source of fuel under pressure.

8. The fuel injector of claim 5 wherein the check valve fully restricts flow from the nozzle to the controllable source of fuel under pressure.

9. A method of operating a fuel injector having a needle in a nozzle, the needle being encouraged to a closed position by a spring, comprising:
controllably coupling high pressure fuel or a vent to:
a) the nozzle through a check valve to encourage the nozzle to move to an open position for fuel injection, the check valve restricting fuel flow in a reverse direction; and,
b) a passive valve to hydraulically encourage the passive valve toward a closed position when high pressure fuel is coupled thereto;
coupling fuel from the nozzle to hydraulically encourage the passive valve to an open position, the passive valve, when in the open position, coupling fuel in the nozzle to hydraulically encourage the needle toward the closed position, and to a flow restriction coupled to a vent.

10. The method of claim 9 further comprised of spring biasing the passive valve toward the closed position.

11. The fuel injector of claim 9 wherein the check valve partially restricts flow from the nozzle to the controllable source of fuel under pressure.

12. The fuel injector of claim 9 wherein the check valve fully restricts flow from the nozzle to the controllable source of fuel under pressure.
